(19) United States
(12) Patent Application Publication
(10) Pub. No.: US 2024/0408700 A1
(43) Pub. Date: Dec. 12, 2024

(54) ADDITIVE MANUFACTURING PROCESS WITH REDUCTION OF THE SURFACE ROUGHNESS OF A SHAPED BODY PRODUCED IN THE MANUFACTURING PROCESS

(71) Applicant: TRUMPF Laser- und Systemtechnik GmbH, Ditzingen (DE)

(72) Inventors: Anne Van Husen, Neustadt an der Weinstrasse (DE); Philipp Wagenblast, Leonberg (DE)

(21) Appl. No.: 18/809,367

(22) Filed: Aug. 20, 2024

Related U.S. Application Data
(63) Continuation of application No. PCT/EP2023/052192, filed on Jan. 30, 2023.

(30) Foreign Application Priority Data
Feb. 28, 2022 (DE) 10 2022 104 752.0

(51) Int. Cl. B23K 26/342; B22F 10/28; B22F 12/41; B22F 12/45; B23K 103/12; B33Y 10/00; B33Y 70/00

(52) U.S. Cl. CPC B23K 26/342; B22F 10/28; B22F 12/41; B22F 12/45; B33Y 10/00; B23K 2103/12; B33Y 70/00

(57) ABSTRACT

A manufacturing process for additively manufacturing a shaped body includes repeatedly adding a further layer to a previous layer arrangement by I) applying a new layer of a powder to the previous layer arrangement, and II) melting the powder of the new layer in a melting region delimited by a contour, with a first high-energy beam having a first melting depth. At least for some of the further layers, the adding of the further layer further includes III) determining a machining part of the contour, and after step II), moving a second high-energy beam along a line of travel extending parallel to the machining part of the contour, thereby the further layer and at least part of an uppermost layer of the previous layer arrangement are melted along the line of travel. The second high-energy beam has a second melting depth that is greater than the first melting depth.

### CROSS REFERENCE TO RELATED APPLICATIONS

This application is a continuation of International Application No. PCT/EP2023/052192 (WO 2023/160955 A1), filed on Jan. 30, 2023, and claims benefit to German Patent Application No. DE 10 2022 104 752.0, filed on Feb. 28, 2022. The aforementioned applications are hereby incorporated by reference herein.

### FIELD

Embodiments of the present invention relate to a manufacturing process for additively manufacturing a shaped body layer by layer.

### BACKGROUND

A manufacturing process for additively manufacturing a shaped body layer by layer has been disclosed, for example, in WO 2018/23171 A1.

Additive manufacturing processes, which have also been disclosed under the keyword “3D printing”, make it possible to manufacture shaped bodies having complex geometries which would not be available, or would be available only with considerable outlay, through conventional manufacturing processes such as milling or casting. The shaped body is manufactured layer by layer, with a respective new layer of a powder being applied to a previous layer arrangement, and the new layer is locally consolidated. The local consolidation is carried out with a high-energy beam, for example a laser beam or an electron beam.

In particular in the case of the manufacture of shaped bodies made of copper-based powder, these shaped bodies often have a high surface roughness on the side faces built up during the manufacture. This surface roughness can be eliminated by reworking processes such as sanding, although this involves considerable outlay.

WO 2018/23171 A1 discloses an additive production process with the application of successive layers of a feed material to a support, a selected region of the layer being melted after each layer has been applied. After the respective melting operation, the layer is investigated for defects, and corresponding partial segments of the melted region of the feed material are determined for reworking by a further melting operation, during which a melt pool with a vapour capillary is produced in the partial segments. This makes it possible to rework and eliminate irregularities on the surface of a respective layer. The intention is that this improves the quality and the service life of the component.

### SUMMARY

A manufacturing process for additively manufacturing a shaped body layer by layer includes repeatedly adding a respective further layer to a respective previous layer arrangement in a direction of a layer sequence. The adding of the respective further layer includes I) applying a new layer of a powder to the previous layer arrangement, and II) melting the powder of the new layer in a melting region, predetermined for the further layer, with a first high-energy beam, with at least part of an uppermost layer of the previous layer arrangement also being melted. The first high-energy beam has a first melting depth in the direction of the layer sequence and a first line energy. The predetermined melting region is delimited by a contour. At least for some of the further layers, the adding of the respective further layer further includes III) determining a machining part of the contour for the contour of the predetermined melting region of the further layer, the machining part being formed by one or more portions of the contour or the entire contour, and after step II), moving a second high-energy beam along a line of travel extending parallel to the machining part of the contour, thereby the further layer and at least part of the uppermost layer of the previous layer arrangement are melted along the line of travel. The second high-energy beam has a second melting depth in the direction of the layer sequence. The second melting depth is greater than the first melting depth by a factor FST, where FST>1.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows, for a first variant of the manufacturing process according to embodiments of the invention, a schematic longitudinal section of a shaped body in a manufacturing chamber, a new layer of powder being applied in the manufacturing chamber (step I);

FIG. 2 shows a schematic longitudinal section of the shaped body in the manufacturing chamber of FIG. 1, a melting region being irradiated with a first high-energy beam (step II);

FIG. 3 shows a schematic longitudinal section of the shaped body in the manufacturing chamber of FIG. 1, after the irradiation by the first high-energy beam (after step II);

FIG. 4 shows a schematic longitudinal section of the shaped body in the manufacturing chamber of FIG. 1, the melting region being irradiated with a second high-energy beam (step III);

FIG. 5 shows, for a second variant of the manufacturing process according to embodiments of the invention, a schematic longitudinal section of a shaped body in a manufacturing chamber, multiple new layers being applied one after another in time to a previous layer arrangement and melted (step I/II repeatedly one after the other);

FIG. 6 shows a schematic longitudinal section of the shaped body of FIG. 5 in the manufacturing chamber after the melting of melting regions in the new layers by the first high-energy beam (after the last step II);

FIG. 7 shows a schematic longitudinal section of the shaped body of FIG. 5 in the manufacturing chamber, the melting region being irradiated with a second high-energy beam (step III);

FIG. 8 shows, for the first and second variants of the manufacturing process according to embodiments of the invention, a schematic longitudinal section of the shaped body after the irradiation by the second high-energy beam (after step III);

FIG. 9 shows, for a third variant of the manufacturing process according to embodiments of the invention, a schematic longitudinal section of the shaped body in the manufacturing chamber, with a slightly inclined side face of the shaped body, during the irradiation by the second high-energy beam (step III);

FIG. 10 shows, for a fourth variant of the manufacturing process according to embodiments of the invention, a schematic longitudinal section of the shaped body in the manufacturing chamber, with a medium-inclined side face of the shaped body, during the irradiation by the second high-energy beam (step III);

FIG. 11 shows, for a fifth variant of the manufacturing process according to embodiments of the invention, a schematic longitudinal section of the shaped body in the manufacturing chamber, with a greatly inclined side face of the shaped body, during the irradiation by the second high-energy beam (step III);

FIG. 12 shows a schematic plan view of a further layer of a layer arrangement, with which the shaped body is manufactured according to a sixth embodiment;

FIG. 13 shows a first schematic central longitudinal section through the layer arrangement of FIG. 12; and

FIG. 14 shows a second schematic peripheral longitudinal section through the layer arrangement of FIG. 12.

### DETAILED DESCRIPTION

Embodiments of the present invention specify an additive manufacturing process for a shaped body, which process can be used to easily reduce the roughness on side surfaces of the shaped body. Embodiments of the invention also provide a shaped body which has a reduced roughness on side surfaces.

Embodiments of the present invention provide a manufacturing process for additively manufacturing a shaped body layer by layer, a further layer being repeatedly added to a respective previous layer arrangement in the direction of a layer sequence, the adding of a respective further layer comprising the following steps:
I. applying a new layer of a powder to the previous layer arrangement;
II. melting the powder of the new layer in a melting region, predetermined for the further layer, with a first high-energy beam, in particular laser beam or electron beam, with at least part of the uppermost layer of the previous layer arrangement also being melted,
the first high-energy beam having a first melting depth in the direction of the layer sequence and a first line energy,
and the predetermined melting region being delimited by a contour.

According to embodiments of the invention, at least for some of the further layers, the adding of the respective further layer also comprises the following step:
III. determining a machining part of the contour for the contour of the predetermined melting region of the further layer, which machining part is formed by one or more portions of the contour or the entire contour,
and, after step II, moving a second high-energy beam, in particular laser beam or electron beam, along a line of travel extending parallel to the machining part of the contour, as a result of which the further layer and at least part of the uppermost layer, in particular the entire uppermost layer, of the previous layer arrangement is melted along the line of travel,
the second high-energy beam having a second melting depth in the direction of the layer sequence, the second melting depth being greater than the first melting depth by a factor FST, where FST>1.

According to embodiments of the present invention, a porosity occurring at or close to the side faces of the shaped body can be selectively reduced. This makes it possible to reduce the surface roughness of the side faces of the shaped body.

In process step III, the powder of the further layer that was melted in step II and the melted powder of the layer or layers of the previous shaped body that is/are next in the direction of the layer sequence below the further layer, and possibly also to a certain extent in process step II non-melted powder, are melted together along the line of travel. As a result, the porosity remaining in the material, in particular after a melting operation during a step II, is reduced. The reduced porosity results in a reduction in the roughness on the side faces, which were built up during the layer-by-layer manufacture, along the contour.

When the further layer is being melted in process step II, owing to a high outward flow of heat into (non-melted) powder that is close to the melting zone, powder particles often become sintered to the (previous) shaped body, in particular if process step II with the first high-energy beam is carried out in the form of heat conduction welding and in particular if the powder consists of a readily thermally conductive material such as copper. In process step III, which is carried out at a greater welding depth, usually a larger proportion of the energy of the second high-energy beam goes into the melting zone than in process step II, with the result that less sintering of powder particles takes place, in particular if process step III is carried out in the form of deep penetration welding. The roughness of the shaped body is generally decisively determined by the last procedure carried out in a respective layer on the side wall of the shaped body, which is what process step III is available for according to embodiments of the invention. It is correspondingly possible to reduce the roughness on the sides of the shaped body.

When the melting region of the further layer is being melted according to process step II, it is additionally possible for the profile of the melt pool produced in the material of the new layer by the first high-energy beam to have a considerable tapering in the direction of the uppermost layer of the previous layer arrangement. This can lead to wedge-shaped edges of the resolidified material in the region of the resulting side faces. In particular, it is also possible during step III for melting of powder that has previously remained unmelted in the further layer or a layer in the previous layer arrangement to occur. These edges can optionally be made smaller or eliminated during step III.

The machining part of the contour and the associated line of travel can be determined solely on the basis of the planned geometry of the shaped body to be manufactured, in particular taking into account overhang parts and projecting parts. An inspection of the respective further layer after step II, in particular to locate surface irregularities, is not necessary for the determination of the machining part of the contour or the line of travel for step III; the measures in WO 2018/23171 A1 can nevertheless additionally be applied (with a corresponding additional line of travel independent of the contour), if desired.

By virtue of the manufacturing process according to embodiments of the invention, complex reworking steps for reducing the roughness of the side surfaces of the shaped body, into which side surfaces it would not be possible to readily machine for example internal channels, are dispensed with.

It often holds true that FST>1.5, preferably FST≥2, preferably FST≥3.

For the first melting depth EST of the first high-energy beam and a layer thickness SD (measured inside the respective melting region) of a respective layer, it typically holds true that EST≥1.1*SD, preferably EST≥1.3*SD, preferably EST≥1.5*SD, and usually also that EST≤3*SD, preferably EST≤2*SD.

For the second melting depth ZST of the second high-energy beam and a layer thickness SD of a respective layer, it typically holds true that ZST≥2*SD, preferably ZST≥3*SD, and usually also that ZST≤8*SD, preferably ZST≤6*SD, preferably ZST≤4*SD.

The first high-energy beam and the second high-energy beam typically have the same spot size and are generated with the same high-energy beam source. To produce the enhanced second melting depth, the second high-energy beam can for example propagate more slowly than the first high-energy beam, and/or the energy output is increased for the second high-energy beam in relation to the first high-energy beam. As an alternative, it is also possible to select different spot sizes for the first high-energy beam and the second high-energy beam, or to select different high-energy beam sources, possibly with different energy outputs and/or different propagation speeds, for producing the first and the second high-energy beam. A spot size can be determined in the plane of the workpiece surface. High-energy beams used according to embodiments of the invention can be for example laser beams or electron beams. The high-energy beams have an energy high enough to melt the material of the powder.

According to embodiments of the invention, the second high-energy beam can be moved with its centre point along the lone of travel, or a moving average (over time) of the position of the centre point is moved along the line of travel (e.g. if a rapid oscillation compared to the advancement is applied to the second high-energy beam).

In the latter case it is possible, for example, for the centre point of the second high-energy beam to have a movement curve with a shape that spatially oscillates (transversely to the local advancement direction), an interpolation line through the turning points of the oscillations corresponding to the line of travel, which is to say extending (substantially) parallel to the machining part of the contour. It is similarly possible, for example, for the centre point of the second high-energy beam to have a movement curve with a spatially oscillating shape, an interpolation line through geometric barycentres in successive periods of the oscillations corresponding to the line of travel, which is to say extending (substantially) parallel to the machining part of the contour, with a respective geometric barycentre of the movement curve being determined in each of the successive periods.

The contour corresponds to the peripheral line of the (predetermined) melting region.

To finish the respective predetermined melting region, patterns, which are also referred to as “hatches” or “hatchings” and define the movement curves or the vectors of the first high-energy beam when the new layer is being melted, are determined.

During the manufacturing process according to embodiments of the invention, specific parameter settings, in particular for the second melting depth (which can be influenced in particular by a second line energy of the second high-energy beam, or the welding speed and the energy output (watts per second), and the spot size of the second high-energy beam), are used to obtain a modified process regime. Step III (“travelling the contour”) makes it possible to selectively shift the formation of the (side) surface layer and bring about a lower porosity and lower roughness of the surface of the shaped body.

A variant of the manufacturing process according to embodiments of the invention is characterized in that it holds true that 1<FST≤10, preferably 1.5≤FST≤8, preferably 2≤FST≤8, preferably 4≤FST≤6. Depending on layer thickness and the number of layers through which the material in step III is to be welded, a suitable FST can be selected, in particular via a suitable line energy. A FST between 1 and 10 typically makes it possible to weld powder material in a sufficient number of layers, and it is possible to smooth the surface of the relevant shaped body without needing to make an unnecessarily high power density available.

An advantageous variant provides that the second high-energy beam has a second line energy, the second line energy being greater than the first line energy by a factor FL, where FL>1,
in particular a spot size of the second high-energy beam being the same as or larger than a spot size of the first high-energy beam. An increase in the line energy from the first high-energy beam to the second high-energy beam is usually easy to set up in equipment terms. In addition, in practice, this procedure has made it possible to reduce the porosity and roughness well, in particular if the same high-energy beam source with a constant spot size has been used to generate the first and the second high-energy beam. The line energy can be increased by reducing the welding speed and/or increasing the energy of the high-energy beam (e.g. a laser power is increased). The line energy (also referred to as energy per unit length) is the energy (joules per m) introduced into the workpiece per unit length of the welding path by a high-energy beam. In addition, it often holds true that FL≥1.3, preferably FL≥1.5, preferably FL≥2, preferably FL≥4.

An advantageous further development of this variant of the process according to embodiments of the invention is distinguished in that it holds true that 1<FL≤20, preferably 1.3≤FL≤10, preferably 2≤FL≤8. A FL between 1 and 20 typically results in a second melting depth sufficient to melt the material of melting regions of multiple successive layers and to fuse the material of a layer to the material of the respective adjacent layers.

Also advantageous is a variant in which a spot size of the second high-energy beam is smaller than a spot size of the first high-energy beam,

in particular the second high-energy beam having a second line energy and the second line energy being the same as or less than the first line energy. By changing the spot size, it is possible to likewise change the welding depth for the first and the second high-energy beam, and also in a relatively straightforward way, in particular with it not being necessary to change the line energy.

In a further variant of the process, step III is carried out when each further layer is being added to the previous layer arrangement. Since in this case the machining parts of the contour of the respective melting region are travelled by the second high-energy beam in each layer in step III, it is possible to take account of deviations between the contours of adjacent layers with respect to their size, shape or position in the respective layer with high accuracy in the respective step III; in respective steps II, a large proportion of melted material can be melted again in steps III, if slopes must be taken into account. Moreover, the melting of material along the contours of the melting regions of the uppermost two (adjacent) layers is sufficient to melt the material in all the layers during steps III, with the result that corresponding small second welding depths can be used in step III.

An alternative advantageous variant of the process is characterized in that step III is carried out when each nth further layer is being added to the previous layer arrangement, it holding true that n≥2. In this configuration, the time spent on carrying out the process according to embodiments of the invention is reduced, since the melting according to step III does not take place in every layer.

A further development of the aforementioned variant is distinguished in that n is selected where n≤ZST/SD, where ZST: second melting depth and SD: layer thickness of a respective layer, in particular it furthermore also holding true that n>(ZST/SD)−1. This ensures that during steps III, all the layers are melted with a saving on time. If the ratio ZST/SD produces an integer, n is preferably the same as this integer. If the ratio ZST/SD produces a rational number, which is not an integer, n preferably corresponds to the closest integer that is less than the ratio ZST/SD. During the melting along the contour of a melting region in a further layer with a second high-energy beam according to step III, the powder material is preferably correspondingly melted as far as the next layer below this further layer in the direction of the layer sequence, in which the melting process has been carried out beforehand according to step III; this is efficient and time-saving.

A variant of the manufacturing process in which the melting in step II is effected by heat conduction welding and the melting in step III is effected by deep penetration welding is preferred. The heat conduction welding in step II can be carried out easily and quickly. The deep penetration welding in step III brings about a weld seam having a uniform and low-defect composition, with good smoothing of the (side) surface of the shaped body. In the case of heat conduction welding, no vapour capillary is produced in the melted material, and/or the weld seam produced has a ratio of depth T to width B where T/B<1.4, usually where 0.7≤T/B≤1.3. In the case of deep penetration welding, a vapour capillary is produced in the melted material, and/or the weld seam produced has a ratio of depth T to width B where T/B>1.4, usually where 1.5≤T/B≤12, preferably where 2≤T/B≤10, preferably between 4≤T/B≤8. It should be noted that the literature sometimes (in addition to heat conduction welding and deep penetration welding) also discusses a further welding regime called transition mode, also referred to as transition mode welding, which lies in the transition area between heat conduction welding and deep penetration welding. The transition mode is not to be discussed in more detail here, especially since the demarcation of the welding regime is not consistent in the literature. According to embodiments of the present invention, heat conduction welding and deep penetration welding can be allocated as indicated above.

In a further variant of the manufacturing process, in step III, a centre point of a cross-sectional area of the second high-energy beam in the melting region of the further layer is moved close to the machining part of the contour of the melting region, at most up to a predetermined safety distance, in particular the safety distance corresponding at least to half the diameter of the cross-sectional area of the second high-energy beam or at least half the width B of a weld seam produced by the second high-energy beam. The safety distance makes it possible, during step III, to avoid undesired melting of powder that has not yet been melted (in particular in a preceding step II). The melting in step III is typically effected substantially only inside the melting region of the further layer by virtue of the safety distance; for this, the safety distance can be selected to correspond to half the spot diameter of the second high-energy beam or half the width of the weld seam. An even larger safety distance makes it possible to have the effect that the fusing of already melted material to parts of the layer arrangement is restricted below this melting region in the direction of the layer sequence, in particular in the case of inclined side faces. Powder material which is below the melting region of the further layer and is not intended to be melted is then not irradiated by the second high-energy beam owing to the safety distance. This avoids an undesired change in shape of the shaped body in step III. The cross-sectional area of the high-energy beam can be determined, for example, on the surface of the further layer.

A refinement of the aforementioned variant of the manufacturing process according to embodiments of the invention is characterized in that a larger safety distance is selected for an overhang part of the machining part of the contour, below which in the direction of the layer sequence there is at least locally unmelted powder in the previous layer arrangement in the region down to the second melting depth and at which an angle of inclination of the shaped body in relation to the direction of the layer sequence reaches at most a first critical angle GW1, than for a machining part of the contour, below which in the direction of the layer sequence there is no unmelted powder in the previous layer arrangement in the region down to the second melting depth, with the first critical angle GW1 being selected to be 30° or less, preferably 25° or less, preferably 20° or less, in particular with the safety distance increasing with the size of the angle of inclination. The angle of inclination can be determined locally in the region of the second melting depth.

This refinement has the effect that, in step III, in the overhang part (which represents a “downskin” region of the shaped body), the melt pool of the second high-energy beam moves closer to the (local) contour as the depth increases, preferably with the melt pool reaching the (local) contour only at its greatest depth. Conversely, by virtue of the smaller safety distance, outside the overhang region it is possible for the melt pool to move closer to the (local) contour or reach it in general along its second melting depth. In this way, the safety distance can easily be selected such that no unmelted powder that is not intended to be fused to the shaped body is melted below the overhang part of the contour in the direction of the layer sequence, and at the same time a high proportion of the material melted previously (in particular in a step II) is melted again in step III to reduce defects. Below the machining part of the contour, below which in the direction of the layer sequence there is no unmelted powder in the previous layer arrangement in the region down to the second melting depth, the shaped body extends down to this depth for example parallel to the direction of the layer sequence in the previous layer arrangement.

What is advantageous is a variant of the process which is characterized in that the machining part of the contour omits at least one projecting part of the contour, below which in the direction of the layer sequence there is at least locally unmelted powder in the previous layer arrangement in the region down to the second melting depth and at which an angle of inclination of the shaped body in relation to the direction of the layer sequence is greater than a second critical angle GW2, with the second critical angle GW2 being selected to be greater than 20°, preferably greater than 25°, preferably greater than 30°. Omitting the projecting part of the contour (which represents a “downskin” region of the shaped body) ensures that no unmelted powder that is not intended to be fused to the shaped body is melted below the projecting part of the contour.

It should be noted that it holds true that GW2>GW1, if overhang parts and projecting parts are taken into account. The angle of inclination can be determined locally in the region of the second melting depth.

In a refinement of the aforementioned variant, the machining part of the contour extends along the entire contour except for the projecting part of the contour. Here, the roughness of the powder melted in step II is reduced along the entire contour of the respective melting region except in the regions in which the smoothing is ruled out owing to the excessively large angle of inclination. Advantageously, a relatively large part of the (side) surface of the shaped body is thus smoothed.

In a preferred variant of the manufacturing process, the machining part of the contour has a proportion of at least 40%, preferably at least 60%, of the entire contour. This ensures that the roughness is reduced at least for approximately half of the respective contour and thus approximately half of the (side) surface of the shaped body.

A further configuration of the manufacturing process is characterized in that the powder contains copper, in particular with at least 50 wt. % copper. In the case of copper materials, a roughness arising on the side faces of 3D printed shaped bodies can be very readily reduced according to embodiments of the invention. A shaped body consisting predominantly of copper is moreover distinguished by a relatively high corrosion resistance and high electrical conductivity and thermal conductivity. Surfaces of copper components produced in a powder bed process typically suffer from a characteristically high porosity, which is exhibited in high surface roughness values, for example of approximately 15 μm, it being possible for these roughness values, for example average roughness values Ra, to vary greatly, for example owing to different layering times in the production process. The manufacturing process according to embodiments of the invention makes it possible in particular to achieve roughness values of below 10 μm. The shaped body is initially built up from the powder bed in a respective layer by a hatching process, and then the contour is travelled with selectively changed operating parameters (“modified process regime”). This results in a considerably reduced surface roughness on the side faces of the finished shaped body. It should be noted that, owing to the relatively high thermal conductivity of pure copper, a reduction in the surface roughness by reducing the spot size of the high-energy beam used or the thickness of the layers is less effective than it is in the case of other materials for additively manufacturing shaped bodies. The modified process regime can be achieved for example in that, for a layer thickness of 60 μm of the powder layers, the line energy of the second high-energy beam is greater than a critical threshold value of 3 J/mm. With a line energy ranging from 2 J/mm to 3 J/mm, improved roughness values typically only occur in some regions of the surface of the shaped body. This also holds true if the layer thickness is increased by a factor of 2.5.

A variant of the manufacturing process in which the first high-energy beam and/or the second high-energy beam is a laser beam and has an average wavelength in a wavelength range from 500 nm to 560 nm is advantageous. The use of a laser beam which comprises light in the green wavelength range reduces the formation of spatter particles while the powder is being melted, in particular in the case of copper-based powder. The effect of this is low-defect and uniform welding. In particular, it is possible to use a laser beam having an average wavelength of 515 nm and a spot with a diameter of 200 μm in the machining plane.

A shaped body according to embodiments of the invention is produced by a manufacturing process according to one of the preceding configurations. The surface roughness of such a shaped body is reduced while it is being produced, with relatively little time being spent.

Further advantages of the embodiments of the invention are evident from the description and the drawing. Similarly, the features mentioned above and those still to be further presented can be used in each case individually or together in any desired combinations. The embodiments shown and described should not be understood as an exhaustive list, but rather as being of an exemplary character for the description of the embodiments of the invention.

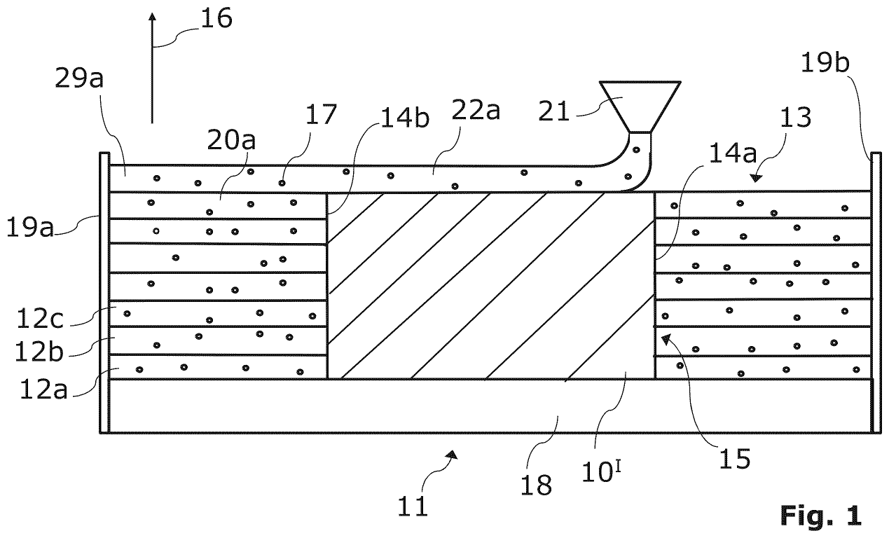

FIG. 1 shows a schematic longitudinal section through a first embodiment of a (partially manufactured) shaped body 10^{I} in a manufacturing chamber 11 for additive manufacture of the shaped body 10^{I}. The shaped body 10^{I} is manufactured layer by layer, with further layers being successively added to a previous layer arrangement 13.

The previous layer arrangement 13 correspondingly comprises a multiplicity of layers, here by way of example denoted by 12a, 12b, 12c. The layers 12a-12c of the previous layer arrangement 13 are present at least partially (outside the volume of the shaped body 10I) in the form of unmelted powder 17, and partially in the form of fused material, which is incorporated in the shaped body 10I. The (partially manufactured) shaped body 10I is thus surrounded by powder 17 in the previous layer arrangement 13.

The shaped body 10I has a first side face 14a and a second side face 14b, which are part of the surface 15 of the shaped body 10I. The sequence of powder layers is oriented upwards in the vertical direction 16. In the embodiment shown, the side faces 14a, 14b of the shaped body 10I also extend in this direction 16.

In this case, the powder 17 is a metallic powder and comprises in particular copper as material. The shaped body 10I and the layer arrangement 13 are arranged on a vertically adjustable lifting platform 18. The shaped body is thus produced on the top side of the lifting platform 18 in the variant shown; if desired, a substrate on which the shaped body is produced can also be arranged on the lifting platform 18 (this case is not illustrated in more detail). The powder layers are held by side walls 19a, 19b in the horizontal direction.

In a step I, illustrated in FIG. 1, of the manufacturing process according to embodiments of the invention in the first variant shown, a new layer 22a of the powder 17 is applied by an application unit 21 to the layer 20a, which is uppermost in the direction 16 of the layer sequence, of the previous layer arrangement 13 in order to expand the previous layer arrangement 13 by a further layer 29a. A spreader can optionally be used to even out the applied new layer 22a (this case is not illustrated in more detail).

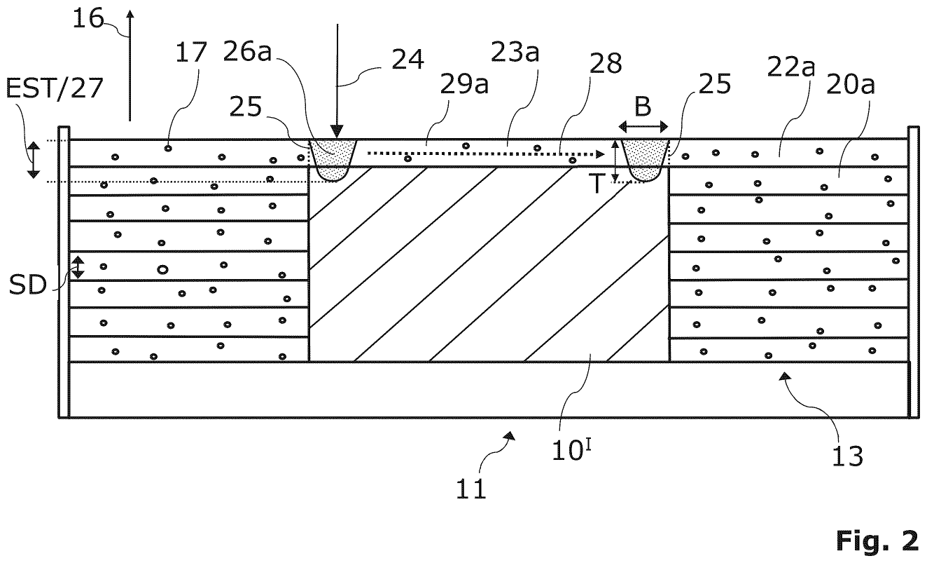

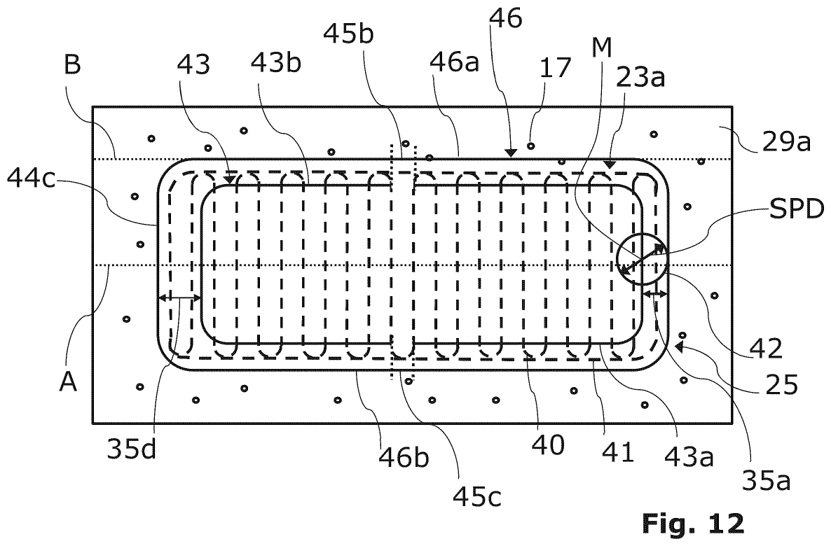

FIG. 2 illustrates the next step, step II, of the first variant of the manufacturing process, a first predetermined melting region 23a (cf. FIG. 12) in the new layer 22a being irradiated with a first high-energy beam 24, in order to melt and consolidate the powder 17 in the melting region 23a. In the variant shown, the high-energy beam 24 is a laser beam, for example having an average wavelength of 515 nm. The first high-energy beam 24 brings about heat conduction welding in the variant shown. The first predetermined melting region 23a is bordered by a contour 25. A first melt pool 26a of the material (formerly powder) melted by the first high-energy beam 24 has, in the cross section shown (which in this case is perpendicular to the advancement direction of the high-energy beam 24 relative to the shaped body 10I), an approximately conical shape and tapers counter to the direction 16 of the layer sequence. The melt pool 26a has a first melting depth 27 (also referred to as EST) and extends down to a part of the uppermost layer 20a of the previous layer arrangement 13 below the new layer 22a; the first melting depth EST corresponds in this case to approximately 1.6 times the first layer thickness SD. The first high-energy beam 24 produces a weld seam, substantially corresponding to the geometry of the melt pool 26a, having a width B and a depth T, where in this case T/B is approximately 0.9. Moving the first high-energy beam 24 perpendicularly to the direction 16 of the layer sequence causes the first melt pool 26a to be displaced along a movement curve 28, in this case in the form of a hatching (cf. in this respect also FIG. 12), which moves the first high-energy beam 24 in the longitudinal section shown in FIG. 2 along the contour 25 perpendicular to the plane of the drawing of FIG. 2. In the longitudinal section of FIG. 2, the powder 17 is melted between the mutually opposite sides of the contour 25 with the first high-energy beam 24, in order to form a further (layer-like) portion of the shaped body 10I in the new layer 22a or the further layer 29a in the manufacturing chamber 11; this portion is integrally connected to the uppermost layer 20a of the shaped body 10I in the previous layer arrangement 13, since the uppermost layer 20a of the shaped body 10I has also been melted by the first high-energy beam 24.

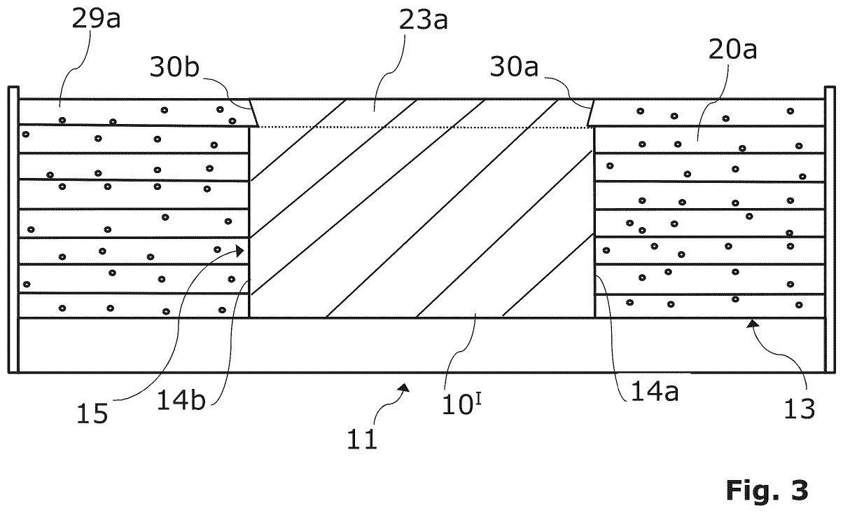

FIG. 3 shows the shaped body 10^{I} in the manufacturing chamber 11 after the irradiation by the first high-energy beam 24 (cf. FIG. 2). After step II, the side faces 14a, 14b of the shaped body 10^{I} have an undesired roughness in the region of the further layer 29a owing to porosity (not illustrated in more detail). There is similarly an undesired roughness on the side faces 14a, 14b in the region of the further layer 29a owing to powder particles (likewise not illustrated in more detail) sintered to the shaped body 10^{I}, since the first high-energy beam 24 has introduced a lot of heat into the non-melted powder 17 adjoining the melt pool 26a.

In the variant shown, notches 30a, 30b, which have a width that increases in the direction towards the uppermost layer 20a of the previous layer arrangement 13 (which is to say downwards in FIG. 3), are also formed in the shaped body 10^{I} by the profile of the first melt pool 26a (cf. FIG. 2) at the periphery of the melting region 23a of the further layer 29a. These notches 30a, 30b may also contribute to an undesired roughness of the side faces 14a, 14b of the shaped body 10^{I} that are part of its surface 15.

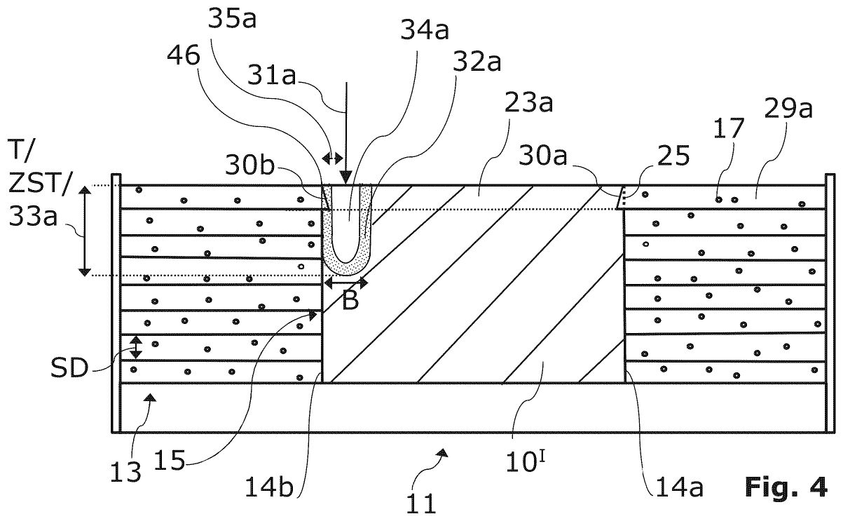

FIG. 4 shows a shaped body 10^{I} in the manufacturing chamber 11, the melting region 23a of the further layer 29a being irradiated with a second high-energy beam 31a according to a next step, step III, of the manufacturing process. The second high-energy beam 31a produces a second melt pool 32a having a second melting depth 33a (also referred to as ZST), which is greater than the first melting depth 27; the second melting depth ZST in this case corresponds to approximately 3.6 times a layer thickness SD. In the variant shown, the second high-energy beam 31a also has a higher line energy than the first high-energy beam 24, for example in that the second high-energy beam 31a is scanned more slowly than the first high-energy beam 24; the laser power and the spot size of the first high-energy beam 24 and of the second high-energy beam 31a are both the same in this example. As an alternative, in another example the spot size (spot diameter on the surface of the upper/further layer 29a) of the second high-energy beam 31a could also be selected to be smaller than the spot size of the first high-energy beam 24, for the same line energy of both high-energy beams 24, 31a (this case is not illustrated in more detail). The second line energy is selected to be high enough for a vapour capillary 34a to be formed in the second melt pool 32a. The second high-energy beam 31a produces a weld seam, substantially corresponding to the geometry of the melt pool 32a, having a width B and a depth T, where in this case T/B is approximately 2.0. The second high-energy beam 31a has the effect of deep penetration welding that part of the shaped body 10^{I} that was melted by the second high-energy beam 31a.

The second high-energy beam 31a is guided along a line of travel extending parallel to the contour 25 (in this respect, see FIG. 12). The second high-energy beam 31a selectively melts the material of the previous layer arrangement 13 and of the further layer 29a only in a region close to the contour 25, substantially in the shaped body 10^{I}. In the process, the porosity, and correspondingly the roughness, in the (re-) melted material of the shaped body 10^{I} close to the side faces 14a, 14b is considerably reduced.

The second high-energy beam 31a is guided at a first safety distance 35a from a machining part 46 of the contour 25 of the melting region (cf. FIG. 12). The safety distance 35a is measured from the (central) beam axis of the high-energy beam 31a or the centre of the associated spot on the layer surface of the further layer 29a to the contour 25 (in the machining part 46), transversely to the line of travel. The first safety distance 35a corresponds in this case to half the diameter of the cross-sectional area of the second high-energy beam 31a or its spot.

The second melt pool 32a passes through the notch 30b and the powder 17 in the notch 30b that was not melted in process step II. The joint melting of the powder 17 in the notch 30b that was not melted in process step II and the powder 17, melted in process step II (cf. FIG. 2), of the shaped body 10^{I} in the surrounding area of the notch 30b causes the notch 30b to become smaller or evened out. A roughness owing to powder particles sintered in the region of the notch 30b is also reduced, since the second high-energy beam 31a concentrates its energy more strongly on the melt pool 32a than the first high-energy beam does. This makes it possible to reduce the roughness of the surface 15 of the shaped body 10^{I} in the region of the side face 14b. The same procedure is correspondingly followed for the notch 30a (this is not illustrated in more detail).

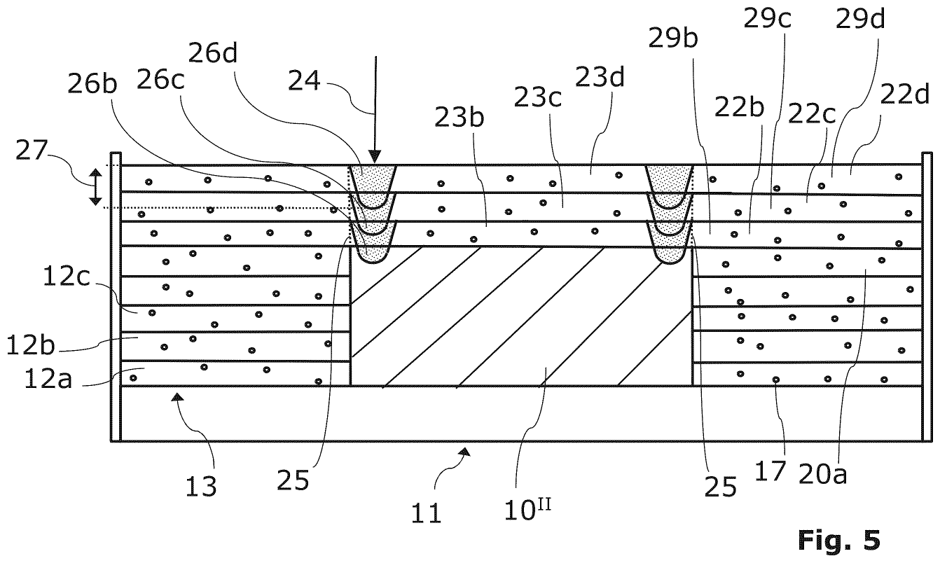

FIG. 5 shows a shaped body 10^{II} in a manufacturing chamber 11 in a second variant of the manufacturing process, which largely corresponds to the first variant of FIG. 1ff; accordingly, only the essential differences will be explained.

Within the context of the second variant of the shaped body 10^{II}, multiple, in this case three, further layers 29b, 29c, 29d are applied one after another by steps I and II one after the other, and a step III comes only after the step II of the third further layer 29d.

In this respect, FIG. 5 highly schematically shows the three new layers 22b, 22c, 22d of powder 17, which are applied one after another in time to the previous layer arrangement 13 (the existing one at the point in time of the application) according to process step I. Before applying a next new layer 22b, 22c, 22d, the powder 17 in each of the new layers 22b, 22c, 22d is melted by the first high-energy beam 24 in associated melting regions 23b, 23c, 23d according to process step II. In this case, the respective first melt pool 26b, 26c, 26d extends with the first melting depth 27 into the next layer below it, which is the respective uppermost layer 20a of the previous layer arrangement 13 (the existing one at the point in time of the application) with the layers 12a, 12b, 12c etc. in the manufacturing chamber 11. The first high-energy beam 24 traverses the respective melting region 23b, 23c, 23d, delimited by a contour 25 (indicated by a dashed line), in each new layer 22b, 22c, 22d, in order to melt the powder 17 in the relevant melting region 23b, 23c, 23d.

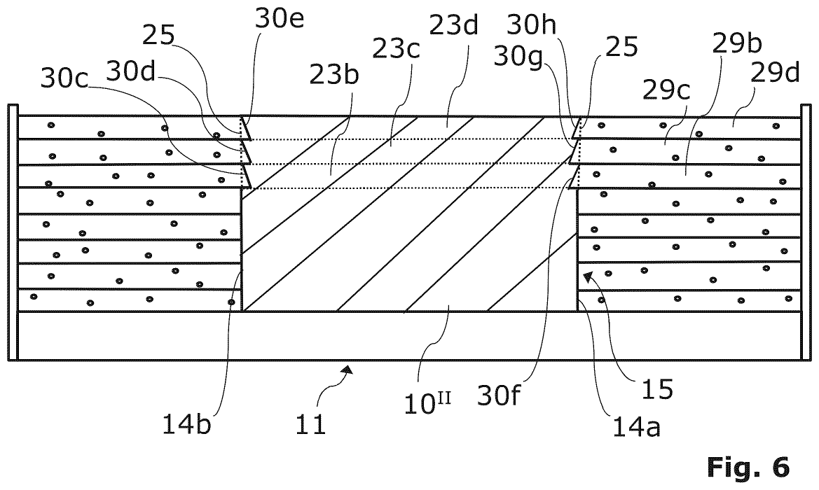

FIG. 6 shows the shaped body 10^{II} in the manufacturing chamber 11 after the melting of the third melting region 23d by the first high-energy beam 24 according to the second variant of the manufacturing process. Close to the side faces 14a, 14b, there is an increase in the porosity in the melted material of the shaped body 10^{II} in the further layers 29b, 29c, 29d. In each further layer 29b, 29c, 29d, in this case notches 30c, 30d, 30e, 30f, 30g, 30h are also formed by the profile of the relevant melt pool 26b, 26c, 26d (cf. FIG. 5) during the melting operation on the contour 25 of the relevant melting region 23b, 23c, 23d. These notches 30c, 30d, 30e, 30f, 30g, 30h can contribute to an undesired roughness of the surface 15 of the shaped body 10^{I}.

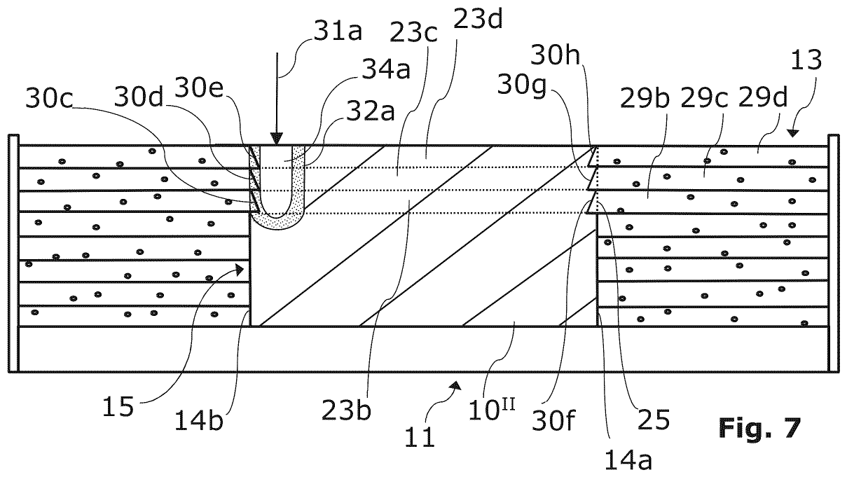

FIG. 7 shows the shaped body 10^{II} in the manufacturing chamber 11 with the notches 30c-30h on the contours of the melting regions of the further layers 29b-29d. Then, according to step III, the shaped body 10^{II} is irradiated along the line of travel extending parallel to the contour 25 with the second high-energy beam 31a, which produces the second melt pool 32a. The second melt pool 32a surrounds the vapour capillary 34a. The (re-) melting of the material, primarily in the shaped body 10^{II}, considerably reduces the porosity in the material close to the side walls 14a, 14b. By contrast to the configuration of step III shown in FIG. 4, in this case the second melt pool 32a passes through all three notches 30c, 30d, 30e of the further three layers 29b, 29c, 29d added to the block, at the same time. This causes the notches 30c, 30d, 30e of these layers 29b, 29c, 29d to jointly become smaller or evened out, as a result of which the roughness of the surface 15 of the shaped body 10^{I} can be reduced.

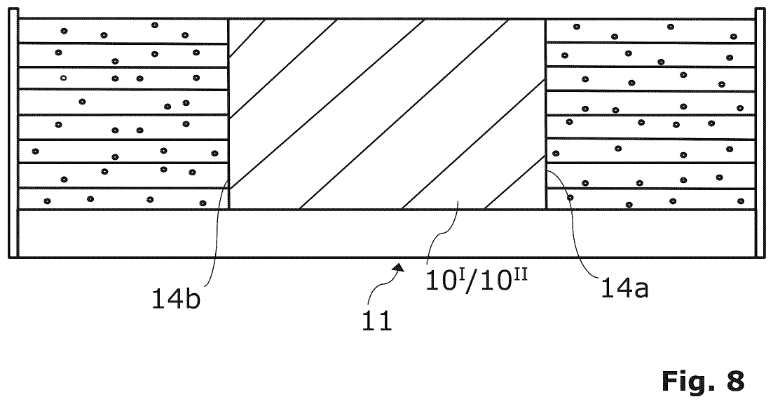

FIG. 8 shows, for the first and the second variant of the manufacturing process, the shaped body 10^{I}, 10^{II} obtained after step III, in the manufacturing chamber 11. The shaped bodies 10^{I}, 10^{II} have a low porosity close to the side faces 14a, 14b, and notches are no longer visible on the side faces 14a, 14b of the shaped body 10^{I}. The side faces 14a, 14b have been smoothed by the second high-energy beam 31a (cf. FIG. 4 and FIG. 7) by the process according to embodiments of the invention.

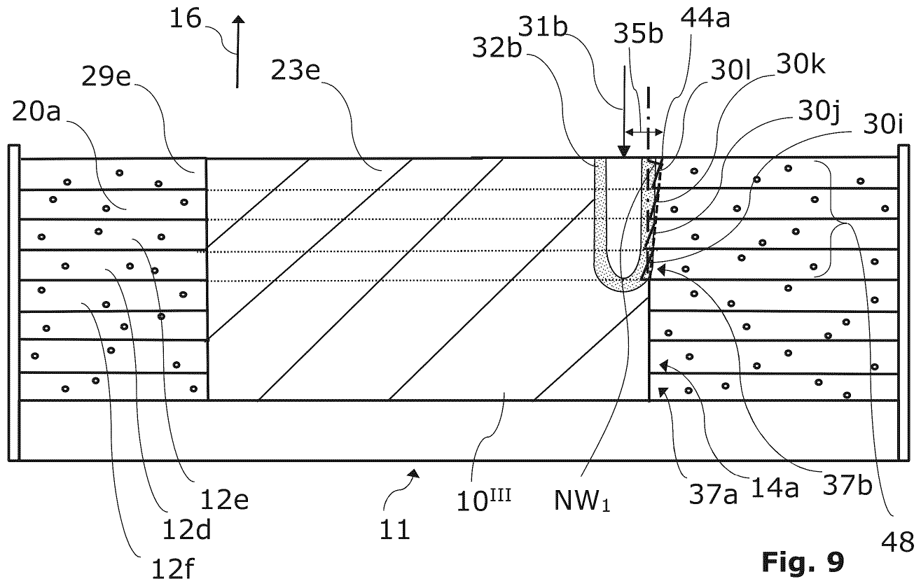

FIG. 9 shows, for a third variant of the process according to embodiments of the invention, a schematic longitudinal section through a third embodiment of the shaped body 10^{III} in the manufacturing chamber 11, in a similar way to what is illustrated in FIG. 7 for the second variant; only the essential differences will be explained. The first side face 14a of the shaped body 10^{II} in this case has a first (lower) wall portion 37a, which extends parallel to the direction 16 of the layer sequence. A second wall portion 37b, which is slightly inclined in relation to the direction 16 of the layer sequence, of the first side face 14a is to be manufactured above the first wall portion 37a. For this, when in this case four further layers (cf. layers 12d, 12e; current top layer 20a of the current previous layer arrangement 13, current further layer 29c) are being added during the respective step II, the melt pool of the first high-energy beam has been displaced increasingly to the outside (in this case to the right) upwardly. Only when the fourth further layer, cf. the current depicted further layer 29e, is added is step III applied, this being illustrated in FIG. 9.

In the upper, second wall portion 37b, notches 30i, 30j, 30k, 30l, which are correspondingly offset perpendicularly to the direction 16 of the layer sequence and have been produced beforehand by irradiation with a first high-energy beam 24 according to step II (cf. FIG. 5), are formed in the uppermost four layers 12d, 12c, 20a, 29c.

The upper ends of the notches 30i, 30j, 30k, 30l of the second wall portion 37b lie on a straight line (illustrated by a dashed line in the figure), which extends outwards from the shaped body 10^{III} at an inclination to the direction 16 of the layer sequence. A first angle of inclination NW₁ is in this case defined as the angle between this inclined line and the direction 16 of the layer sequence. The notches 30i, 30j, 30k, 30l are displaced further to the outside, as seen from the shaped body 10^{III}, the further up they are arranged in the direction 16 of the layer sequence.

According to step III, the further layer 29e is irradiated along the line of travel, which extends parallel to the contour, with a second high-energy beam 31b, which produces a second melt pool 32b extending through—and even in this case a little beyond—the four uppermost layers 12d, 12e, 20a, 29e (“smoothing block” 48). In this case, the second high-energy beam 31b is radiated in with such a second safety distance 35b from an overhang part 44a of a machining part of the contour of the melting region 23e of the current further layer 29e that the outer periphery of the melt pool 32b precisely makes contact with the contour of the next layer 12f below the smoothing block 48 on the top side of said next layer. The position of the overhang part 44a can be allocated to the upper end of the uppermost notch 30l.

The second melt pool 32b completely passes through the notch 30i, which adjoins the layer 12f, and the unmelted powder 17 within it, and virtually completely evens out this notch 30i. Increasingly small proportions of the second melt pool 32b pass through the notches 30j, 30k, 30l that follow this notch 30i in the direction 16 of the layer sequence. Accordingly, the notches 30j, 30k, 30l are evened out to an increasingly small extent in the direction 16 of the layer sequence. The roughness of the second wall portion 37b of the first side face 37a of the shaped body 10^{II} is thus reduced to a lesser extent than in the case of the first wall portion 37a, oriented in the direction of the layer sequence, of the first side face 14a of the shaped body 10^{II}.

Step III, or the second high-energy beam 31b, is preferably applied subsequently after each added further layer, as a result of which then, for all the layers 12e, 20a, 29e further up, it is thus possible to achieve complete evening-out of the associated notches 30j, 30k, 30l.

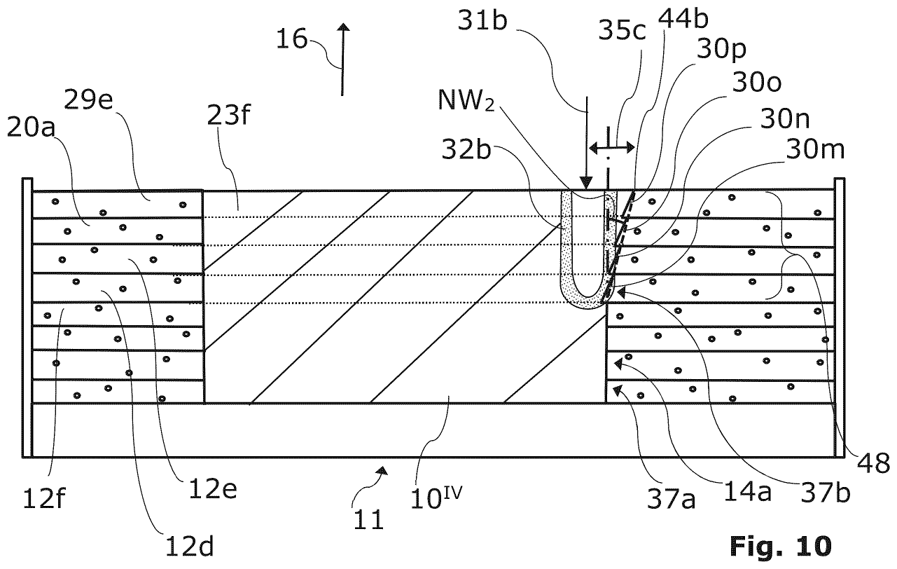

FIG. 10 shows, for a fourth variant of a manufacturing process according to embodiments of the invention, a schematic longitudinal section through a fourth embodiment of the shaped body 10^{IV} in the manufacturing chamber 11, in a similar way to what is illustrated in FIG. 9, only the essential differences being explained.

The second wall portion 37b of the first side face 14a in this case is to be manufactured with a somewhat greater angle of inclination NW₂. The notches 30m, 30n, 30o, 30p in the uppermost four layers 12d, 12e, 20a, 29e of the smoothing block 48 are in this case offset from one another to a greater extent transversely to the direction 16 of the layer sequence.

The second high-energy beam 31b is radiated in with such a third safety distance 35c from an overhang part 44b of the machining part of the contour of the melting region 23f of the uppermost layer (current further layer) 29e of the smoothing block 48 that the outer periphery of the melt pool 32b precisely makes contact with the contour of the next layer 12f below the smoothing block 48 on the top side of said next layer. Since the second angle of inclination NW₂ is greater than the first angle of inclination NW₁, the third safety distance 35c is also greater than the second safety distance 35b (cf. FIG. 9). In this case, the second melt pool 32b in turn virtually completely passes through the notch 30m, which adjoins the first wall portion 37a. The notches 30n, 30o, 30p that follow this notch 30m in the direction 16 of the layer sequence are encompassed by proportions of the second melt pool 32b that are in each case a little smaller than in the case of the third embodiment, shown in FIG. 9, of the shaped body 10^{III}. In particular, the second melt pool 32b does not extend to the uppermost notch 30p in the direction 16 of the layer sequence. Accordingly, the notches 30m, 30n, 30o, 30p are evened out to a smaller extent in the direction 16 of the layer sequence than in the case of the third embodiment, shown in FIG. 9, of the shaped body 10^{III}, with the result that the surface roughness of the shaped body 10^{III} is also reduced to a lesser extent.

Therefore, step III, or the second high-energy beam 31b, is preferably in turn applied subsequently after each added further layer.

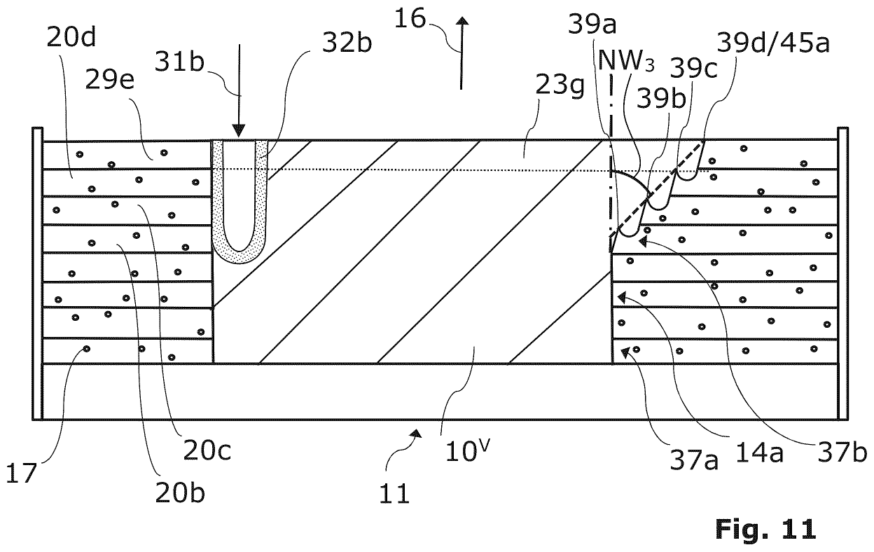

FIG. 11 shows, for a fifth variant of the manufacturing process according to embodiments of the invention, a schematic longitudinal section through a fifth embodiment of the shaped body 10Y in the manufacturing chamber 11, in a similar way to what is illustrated in FIG. 9; therefore, only the essential differences will be explained.

The second wall portion 37b of the first side face 14a in this case is to be manufactured with a much greater angle of inclination NW₃. The first side face 14a of the shaped body 10^{IV} has a first wall portion 37a, which extends parallel to the direction 16 of the layer sequence. In this case, above the first wall portion 37a, a second wall portion 37b of the first side face 14a with prongs 39a, 39b, 39c, 39d, offset perpendicularly to the direction 16 of the layer sequence, is formed in the uppermost four layers 20b, 20c, 20d, 29e, the upper ends of the prongs 39a, 39b, 39c, 39d lying on a straight line (illustrated by a dashed line in the figure), which has a third angle of inclination NW₃ in relation to the direction 16 of the layer sequence that is greater than the angle of inclination NW₂ in the case of the third embodiment of the shaped body 10^{III} (cf. FIG. 10). The prongs 39a, 39b, 39c, 39d have been produced beforehand with a first high-energy beam 24 according to step II (cf. FIG. 5). The upper end of the uppermost prong 39a defines the position of a projecting part 45a of a contour of the melting region 23g of the current, further layer 29c.

The second wall portion 37b has an inclination defined by the third angle of inclination NW₃, which is of such a size that radiating the second high-energy beam 31b in above the second wall portion 37b would produce a second melt pool 32b, which would extend considerably into the intentionally unmelted powder 17 below the second wall portion 37b, even if the second high-energy beam was applied very close to the plane of the first wall portion 37a. It is therefore not expediently possible to use the second high-energy beam 31b in the region of the second wall portion 37b having such an inclination. Correspondingly, such projecting portions of the contour are skipped in the machining part in the case of the fifth variant shown.

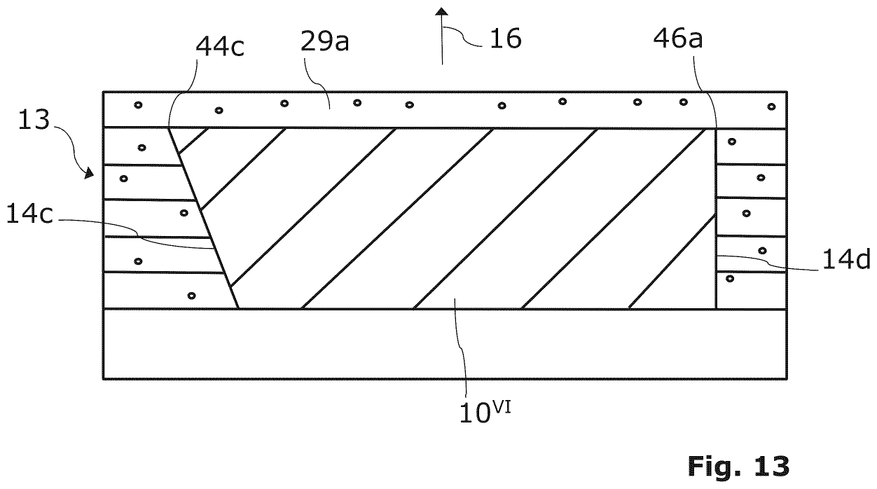

FIG. 12 schematically shows a plan view of a previous layer arrangement (cf. FIG. 13, reference sign 13 there) with a further layer 29a arranged thereon with a predetermined melting region 23a, which is bounded by a contour 25 (cf. also FIG. 3). The further layer 29a is to be consolidated in the melting region 23a.

In step II, the melting region 23a is worked with a first high-energy beam during a heat conduction welding operation which acts over its entire surface area (see also FIG. 3). A dashed line in this case illustrates a hatching line 40, along which the first high-energy beam is moved to melt the powder 17 in the melting region 23a, the hatching line 40 being stored in memory in an electronic controller (not shown). The first high-energy beam is in this case also moved along a contour line of travel 41 parallel to the contour 25 of the melting region 23a, in order to continuously form the contour 25 of the melting region 23a. In step II, the first high-energy beam is typically moved over the further layer 29a with a uniform line energy ELE given a uniform first melting depth EST (if the line energy or the melting depth in step II is not uniform, the maximum value occurring in step II can be utilized for ELE and EST).

In step III, a second high-energy beam is used. It is moved along a line of travel 43, which in principle extends parallel to the contour 25; the (present) location of the second high-energy beam can be specified on the basis of its (present) centre point M on the surface of the further layer 29a. In order to take into account particular features of the geometry of the shaped body to be manufactured, the line of travel is adapted.

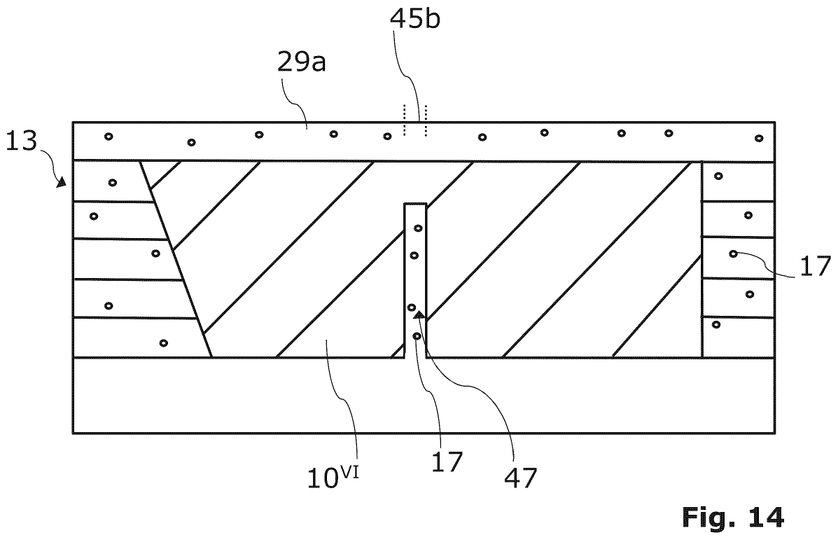

Initially, a machining part 46 is determined for the contour 25, which can comprise one or more portions of the contour 25. In the present case, the machining part 46 comprises two portions 46a and 46b of the contour 25, which overall correspond to the contour 25 with omission of two projecting parts 45b, 45c (in this respect, see FIG. 14). The line of travel 43 extends parallel to the two portions 46a, 46b of the machining part 46 of the contour 25. Accordingly, the line of travel 43 thus likewise has two portions 43a, 43b in this case. The ends of the projecting parts 45b, 45c are indicated by dotted lines; cf. also FIG. 11. Cutting out the projecting parts 45b, 45c for the line of travel 43 makes it possible to prevent the second high-energy beam 31a from melting powder 17 below the projecting parts 45b, 45c that was not intended to be melted by the first high-energy beam 24.

The second high-energy beam has (on the surface of the further layer 29e, which is to say with its “spot”) a cross section 42 which in this case is approximately circular. The cross section has a spot diameter SPD and the centre point M. The spot diameter SPD is a measure of the spot size of a high-energy beam, in this case the second high-energy beam. The spot diameter SPD may be determined, for example, in accordance with the 86% criterion (86% of the energy output of the high-energy beam is within a circle having the spot diameter).

For the portion 43a and the regions of the portion 43b of the line of travel 43 that extend from left to right in FIG. 12, a safety distance 35a of the spot (i.e. its centre point M) from the contour 25 corresponds to half the diameter SPD of the spot. In a region of the portion 43b of the line of travel 43 that extends vertically in FIG. 12, the safety distance 35d is much greater, in this case, accordingly, approximately 0.75 times the spot diameter SPD. This makes it possible to take into account that the contour 25 extends in the form of an overhang part 44c in the vertically extending region of the portion 43b (in this respect, see FIG. 13). It is thereby possible to prevent the second high-energy beam 31a from melting powder 17 below the overhang part 44c of the contour 25 that was not intended to be melted by the first high-energy beam 24.

In step III, the second high-energy beam is typically moved via the line of travel 43 with a uniform second line energy ZLE given a uniform second melting depth ZST (if the line energy or the melting depth in step III is not uniform, the minimum value occurring in step II can be utilized for ZLE and ZST).

In the sixth variant shown, it is provided that a factor FL=ZLE/ELE where FL=4 is selected. It is also provided that a factor FST=ZST/EST where FST=3 is selected.

FIG. 13 schematically shows a longitudinal section through the previous layer arrangement 13 and the further layer 29a along the (centre) line A in FIG. 12. The further layer 29a is applied to the previous layer arrangement 13, in which the sixth embodiment of the shaped body 10^{VI} is arranged. The shaped body 10^{VI} in particular has a side face 14c, which is inclined relative to the vertical direction 16 of the layer sequence and extends below the overhang part 44c of the contour 25; in this case, a larger safety distance should be applied (cf. FIG. 12); this safety distance can ensure that the melt pool of the second high-energy beam does not undesirably extend into powder that is not yet melted. By contrast, below the machining part 46a of the contour 25 that is situated opposite the overhang part 44c, the shaped body 10^{VI} is formed with a side face 14d oriented in the vertical direction 16; in this case, a smaller safety distance is sufficient (cf. FIG. 12).

FIG. 14 schematically shows a longitudinal section through the previous layer arrangement 13 and the further layer 29a along the line B (close to the periphery) in FIG. 12. The shaped body 10^{VI} has a clearance 47, in which there is powder 17 that is not intended to be melted, below the projecting part 45b (the boundary of which is indicated by dotted lines). The line of travel of the second high-energy beam is interrupted in the region of the projecting part 45b (cf. FIG. 12).

As described above, embodiments of the invention relate to a manufacturing process for additively manufacturing a shaped body (10^{I}) layer by layer, a further layer (29a) being repeatedly added to a respective previous layer arrangement in the direction of a layer sequence, in each case comprising the following steps:
I. applying a new layer (22a) of a powder (17) to the previous layer arrangement (13);
II. melting the powder (17) of the new layer (22a) and at least part of the uppermost layer of the previous layer arrangement (13) in a melting region (23a), predetermined for the further layer (29a) and having a contour (25), with a first high-energy beam (24), in particular laser beam or electron beam,
is characterized in that, at least for some of the further layers (29a), the adding of the further layer (29a) also comprises the following step:
III. determining a machining part (46) of the contour (25) for the contour (25),
and, after step II, moving a second high-energy beam (31a), in particular laser beam or electron beam, along a line of travel extending parallel to the machining part (46), as a result of which the further layer (29a) and at least part of the uppermost layer of the previous layer arrangement (13) is melted along the line of travel,
the second high-energy beam (31a) having a second melting depth (33a) greater than the first melting depth (EST) of the first high-energy beam.
Embodiments of the invention make it possible to reduce the surface roughness of the side faces of the shaped body.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

10^{I-VI} Shaped body
11 Manufacturing chamber
12a-f Layers
13 Previous layer arrangement
14a-d Side faces
15 Surface of the shaped body
16 Direction of the layer sequence
17 Powder
18 Lifting platform
19a,b Side walls
20a-d Uppermost layer (of the previous layer arrangement)
21 Application unit
22a-d New layer
23a-g Melting region
24 First high-energy beam
25 Contour
26a-d First melt pool
27 First melting depth
28 Movement curve
29a-e Further layer
30a-p Notches
31a,b Second high-energy beam
32a,b Second melt pool
33a Second melting depth
34a Vapour capillary
35a-d Safety distance
37a First wall portion
37b Second wall portion
39a-d Prongs
40 Hatching line (step II)
41 Contour line of travel (step II)
42 Cross section of the second high-energy beam
43 Line of travel
43a,b Portions of the line of travel
44a-c Overhang parts
45a-c Projecting parts
46 Machining part
46a,b Portions of the contour that belong to the machining part
47 Clearance
48 Smoothing block
B Width (of the weld seam)
EST First melting depth
M Centre point of the cross-sectional area of the second high-energy beam
NW₁ Angle of inclination
NW₂ Angle of inclination
NW₃ Angle of inclination
SD Layer thickness
SPD Diameter of the high-energy beam/spot
T Depth (of the weld seam)
ZST Second melting depth

1. A manufacturing process for additively manufacturing a shaped body layer by layer, the method comprising:
repeatedly adding a respective further layer to a respective previous layer arrangement in a direction of a layer sequence,
wherein the adding of the respective further layer comprises:
I. applying a new layer of a powder to the previous layer arrangement; and
II. melting the powder of the new layer in a melting region, predetermined for the further layer, with a first high-energy beam, with at least part of an uppermost layer of the previous layer arrangement also being melted, the first high-energy beam having a first melting depth in the direction of the layer sequence and a first line energy, and the predetermined melting region being delimited by a contour,
wherein at least for some of the further layers, the adding of the respective further layer further comprises:
III. determining a machining part of the contour for the contour of the predetermined melting region of the further layer, the machining part being formed by one or more portions of the contour or the entire contour, and,
after step II, moving a second high-energy beam along a line of travel extending parallel to the machining part of the contour, thereby the further layer and at least part of the uppermost layer of the previous layer arrangement being melted along the line of travel, the second high-energy beam having a second melting depth in the direction of the layer sequence, the second melting depth being greater than the first melting depth by a factor FST, wherein FST>1.

2. The manufacturing process according to claim 1, wherein 1<FST≤10.

3. The manufacturing process according to claim 1, wherein the second high-energy beam has a second line energy, the second line energy being greater than the first line energy by a factor FL, wherein FL>1, and
wherein a spot size of the second high-energy beam is same as or larger than a spot size of the first high-energy beam.

4. process according to claim 3, wherein 1<FL≤20.

5. The manufacturing process according to claim 1 wherein a spot size of the second high-energy beam is smaller than a spot size of the first high-energy beam, and
wherein the second high-energy beam has a second line energy, the second line energy being same as or less than the first line energy.

6. The manufacturing process according to claim 1, wherein step III is carried out when each further layer is being added to the previous layer arrangement.

7. The manufacturing process according to claim 1 wherein step III is carried out when each nth further layer is being added to the previous layer arrangement, wherein n>2.

8. The manufacturing process according to claim 7, wherein n is selected so that n≤ZST/SD, and n>(ZST/SD)−1, wherein ZST is the second melting depth, and SD is a layer thickness of a respective layer.

9. The manufacturing process according to claim 1, wherein the melting in step II is effected by heat conduction welding, and the melting in step III is effected by deep penetration welding.

10. The manufacturing process according to claim 1, wherein, in step III, a centre point of a cross-sectional area of the second high-energy beam in the melting region of the further layer is moved close to the machining part of the contour of the melting region, at most up to a predetermined safety distance, the safety distance corresponding at least to half of a diameter of the cross-sectional area of the second high-energy beam or at least half of a width of a weld seam produced by the second high-energy beam.

11. The manufacturing process according to claim 10, wherein a larger safety distance is selected for an overhang part of the machining part of the contour, below which in the direction of the layer sequence there is at least locally unmelted powder in the previous layer arrangement in a region down to the second melting depth, and at which an angle of inclination of the shaped body in relation to the direction of the layer sequence reaches at most a first critical angle, than for a second part of the machining part of the contour, below which in the direction of the layer sequence there is no unmelted powder in the previous layer arrangement in the region down to the second melting depth, with the first critical angle being 30° or less.

12. The manufacturing process according to claim 11, wherein the safety distance increases with a magnitude of the angle of inclination.

13. The manufacturing process according to claim 1, wherein the machining part of the contour omits at least one projecting part of the contour, below which in the direction of the layer sequence there is at least locally unmelted powder in the previous layer arrangement in a region down to the second melting depth, and at which an angle of inclination of the shaped body in relation to the direction of the layer sequence is greater than a second critical angle, with the second critical angle being greater than 20°.

14. The manufacturing process according to claim 13, wherein the machining part of the contour extends along the entire contour except for the projecting part of the contour.

15. The manufacturing process according to claim 1 wherein the machining part of the contour has a proportion of at least 40% of the entire contour.

16. The manufacturing process according to claim 1, wherein the powder contains copper.

17. The manufacturing process according to claim 1, wherein the first high-energy beam and/or the second high-energy beam is a laser beam and has an average wavelength in a wavelength range from 500 nm to 560 nm.
